(19) United States
(12) Patent Application Publication
(10) Pub. No.: US 2016/0374393 A1
(43) Pub. Date: Dec. 29, 2016

(54) ELECTRONIC CIGARETTE ATOMIZER

(71) Applicant: HK TRIANGLE CO., LIMITED, Hong Kong (CN)

(72) Inventor: Wei CHEN, Ezhou City (CN)

(21) Appl. No.: 15/039,962

(22) PCT Filed: May 9, 2014
(86) PCT No.: PCT/CN2014/077165

§ 371 Date: May 27, 2016

(30) Foreign Application Priority Data
Nov. 28, 2013 (CN) 201310614903.4
Jan. 21, 2014 (CN) 201410025149.5

(51) Int. Cl. A24F 47/00; H01R 13/62

(52) U.S. Cl. CPC A24F 47/008; H01R 13/62

(57) ABSTRACT

The invention provides an electronic cigarette atomizer comprising:
an outer housing enclosing an inner pipe; and
a heating element located substantially within the inner pipe which is electrically connected to a least one electrical connector pin;
wherein the heating element and the or each electrical connector pin are secured in contact with each other with a fastening sleeve.

### TECHNICAL FIELD OF THE INVENTION

The present invention relates to electronic cigarettes and in particular, to improvements in atomizers to be used in electronic cigarettes.

### BACKGROUND TO THE INVENTION

Atomizers for use in electronic cigarettes typically include a heating wire which heats up when passing a current through the wire due to electrical resistance. In prior art atomizers, the heating wire is connected to the power supply directly, or via intermediary electrical connectors. Typically, the heating wire is connected to the power supply/electrical connectors by soldering them together. It has been known for such connections to break not only causing the electronic cigarette to malfunction, but also allowing for the solder to be mistakenly inhaled by a user.

It is known in the art to provide electronic cigarettes which comprise an atomizer component and a power supply component which are releasably connectable. Electronic cigarettes of this type allow for the atomizer, or indeed for the power supply component, to be replaced. This may be necessary when a user has exhausted the liquid contained within the atomizer, has drained the power supply, or when either component becomes faulty. Conventionally, the atomizer component and the power supply component are releasably connectable by means of a screw fit connection. Connections of this type have the disadvantage that they may become damaged through over tightening, or may become worn over time leading to a less secure connection.

It would therefore be advantageous to provide an atomizer component for an electronic cigarette which does not include electrical connections which are soldered together.

It would also be advantageous to provide an electronic cigarette having releasably connectable atomizer and power supply components which are easily connectable/detachable and have increased longevity.

It is an aim of embodiments of the present invention to overcome or mitigate at least one of the problems in the prior art as described above.

### SUMMARY OF THE INVENTION

According to a first aspect of the present invention there is provided an electronic cigarette atomizer comprising: an outer housing enclosing an inner pipe; and a heating element located substantially within the inner pipe which is electrically connected to at least one electrical connector pin; wherein the heating element and the or each electrical connector pin are secured in contact with each other with a fastening sleeve.

The fastening sleeve may be formed from a polymeric material which may be a resilient material. In some embodiments the fastening sleeve comprises a resilient polymeric material such as silicone, or latex, or synthetic rubber for example. In some embodiments the fastening sleeve comprises a resilient material which urges the or each electrical connector pin into contact with the heating element.

In some embodiments the electrical connection is formed by contacting at least one conductive surface of the heating element with a corresponding conductive surface of the or each electrical connector pin. In other embodiments there may be provided intermediary electrical connection means between the heating element and the or each connector pin.

In some embodiments the heating element comprises a heating wire. In such embodiments each end of the heating wire may be connected to respective electrical connector pins.

The outer housing may comprise a main body portion enclosing the inner pipe and the heating element, and an extended end portion which protrudes from one end of the main body portion. In such embodiments, the extended portion may comprise a connection means operable to connect the atomizer to a further component of an electronic cigarette. In some embodiments the connection of the atomizer to the further component of an electronic cigarette forms an electrical connection between the two. In some embodiments the or each electrical connector pin extend from within the main body portion of the atomizer into the extended portion such that the or each pin may be electrically connected to the further component of an electronic cigarette via at least one electrical connection located within the further component.

In some embodiments the fastening sleeve is configured such that it ensures that the or each electrical connector pin is correctly aligned with respect to the at least one electrical connection on the further component of an electronic cigarette. In some embodiments the fastening sleeve may comprise a substantially elliptical cross-section which may be located within the outer housing of the atomizer in either a first orientation or a second orientation. In embodiments wherein there is provided a pair of electrical connector pins, the first orientation may correspond to the first connector pin being aligned to connect with a first electrical connection of the further component and the second electrical connector pin being aligned to connect with a second electrical connection of the further component. The second orientation may correspond to the first connector pin being aligned to connect with the second electrical connection of the further component and the second electrical connector pin being aligned to connect with the first electrical connection of the further component.

In some embodiments the atomizer is prevented from being assembled incorrectly by ensuring that each electrical connector pin is correctly aligned with an electrical connection on the further component of an electronic cigarette independent of the orientation of the fastening sleeve.

The outer housing may also comprise an elliptical cross-section and the further component may comprise an elliptical cross-section. This configuration allows effective coupling of the housing and further component whilst allowing the or each connector pin to be aligned correctly when the fastening sleeve is in either of the first or second configurations, for example.

The further component of the electronic cigarette may comprise a power supply means such as a battery, for example. The battery may comprise a single-use battery, or a rechargeable battery for example.

In some embodiments the atomizer further comprises a liquid absorbent material located within the atomizer. In some embodiments the liquid absorbent material is located on the outer surface of the inner pipe of the atomizer.

The liquid absorbent material may be a filler material, for example. In some embodiments the liquid absorbent material comprises a fabric. The fabric may be cotton and in some embodiments the fabric comprises tobacco cotton, cotton wool, cotton gauze, or any combination thereof.

In further embodiments the heating element comprises a heating wire which is wrapped around a wick. The wick may be connected to the liquid absorbent material and is operable to draw liquid from the liquid absorbent material and towards the heating wire.

The outer housing of the atomizer may be formed from any suitable rigid material which may be a polymeric material, a metal or an alloy, for example. In some embodiments the outer housing of the atomizer is formed from a plastics material which may be polypropylene, for example.

In some embodiments the atomizer may be configured such that it is releasably connectable with a further component of an electronic cigarette. The releasable connection may comprise a plug and socket connection, for example.

The atomizer may further comprise a mouth piece being operable in use to allow vapour produced within the atomizer to be expelled through the mouth piece for inhalation by a user. In some embodiments the mouth piece comprises a cover located on an outer surface of the mouth piece.

In some embodiments the atomizer may be a drip tip atomizer. In such embodiments the drip tip atomizer is configured to allow a user to drip a liquid solution into the atomizer. In such embodiments the atomizer is configured such that the liquid solution may be dripped directly onto the heating element of the atomizer.

In other embodiments the atomizer may be a cartomizer which may comprise an atomizer as hereinbefore described and a cartridge. The cartridge may comprise a reservoir of liquid solution. In such embodiments, the atomizer is configured such that the liquid solution is heated and vaporised upon the operation of the heating element.

According to a second aspect of the present invention there is provided an electronic cigarette atomizer which is releasably connectable to a further component of an electronic cigarette by means of a plug and socket connection.

The atomizer may be electrically connectable to the further component using the plug and socket connection.

The atomizer may comprise a main body portion and an extended portion which protrudes from a portion of the main body portion. In such embodiments, the extended portion may comprise the releasable connection means operable to connect the atomizer to a further component of an electronic cigarette.

In embodiments wherein the connection of the atomizer to the further component of an electronic cigarette forms an electrical connection between the two, the atomizer may comprise electrical connector pins extending from within the main body portion of the atomizer into the extended portion such that they may be electrically connected to the further component of an electronic cigarette.

In some embodiments a portion of the atomizer may be dimensioned such that it can be located within a recess or aperture within a further component of an electronic cigarette forming the plug and socket connection. In other embodiments the atomizer may comprise a recess into which a portion of a further component of an electronic cigarette may be located to form the plug and socket connection.

The further component of the electronic cigarette may comprise a power supply means such as a battery, for example. The battery may comprise a single-use battery or a rechargeable battery, for example.

In some embodiments the atomizer comprises electrical components located within the atomizer which are secured in contact with each other with a fastening sleeve.

In some embodiments the atomizer comprises a mouthpiece having a cover located on the outer surface thereof.

The atomizer may comprise an atomizer in accordance with the first aspect of the present invention.

According to a third aspect of the present invention there is provided an electronic cigarette comprising an outer housing comprising a mouth piece operable in use to allow vapour produced within an atomizer located within or connected to the housing to be expelled therethrough; wherein the mouth piece comprises a resilient material.

The mouthpiece may be connected to or formed over or around the outer surface of the housing, and may comprise a cover.

In some embodiments the mouth piece may comprise an aperture to allow the vapour to be expelled from within the atomizer. In some embodiments the atomizer may comprise a drip tip atomizer and the mouth piece may be configured to allow a user to drip liquid into the atomizer through the aperture.

In some embodiments the cover comprises an aperture through which vapour produced within the atomizer may be expelled which may also be configured to allow a user to drip liquid into the atomizer through the aperture. In such embodiments the cover may be permanently connected to the outer surface of the mouth piece.

In other embodiments the cover is removable from the outer surface of the mouth piece. In such embodiments the cover may be removed from the outer surface of the mouth piece in order to access the aperture located within the mouthpiece.

The mouthpiece may be formed from silicone, natural or synthetic latex, natural or synthetic rubber, or the like, for example.

In some embodiments the electronic cigarette comprises electrical components located within the atomizer which are secured in contact with each other with a fastening sleeve.

In some embodiments the housing is releasably connectable to a further component of an electronic cigarette by means of a plug and socket connection.

The electronic cigarette may comprise an atomizer in accordance with the first and/or second aspects of the present invention.

According to a fourth aspect of the present invention there is provided an electronic cigarette comprising: an atomizer in accordance with the first, second and/or third aspect of the present invention; and a power supply component comprising a power supply means and at least one electrical connector pin electrically connected to the power supply means.

In some embodiments the atomizer and the power supply component are releasably connectable means of a plug and socket connection. The atomizer and the power supply component may be electrically connectable using the plug and socket connection. In embodiments wherein the atomizer comprises a heating wire, the heating wire may be powered by the power supply means.

In some embodiments the electrical connection between the atomizer and the power supply component comprises electrically connecting electrical connector pins located within the atomizer to respective electrical connector pins within the power supply component.

In some embodiments the power supply means of the power supply component comprises a battery. In such embodiments the battery may comprise a single-use battery, or a rechargeable battery such as a lithium ion battery, for example.

In embodiments wherein the power supply means comprises a single use battery there is also provided a means to access and remove the battery from within the power supply component such that it can be replaced.

In embodiments wherein the power supply means comprises a rechargeable battery, the battery may be charged whilst within the power supply component. In such embodiments the power supply component further comprises a means to connect a charging apparatus thereto in order to charge the battery. In other embodiments the rechargeable battery is removable from within the power supply component and is charged separate from the component.

The electronic cigarette of the third or fourth aspects of the invention may further comprise an LED controlled by a printed circuit board. In such embodiments the LED may be powered by the power supply. In some embodiments the LED is operable in use to indicate the operational status of the electronic cigarette.

### DETAILED DESCRIPTION OF THE INVENTION

In order that the invention may be more clearly understood an embodiment thereof will now be described, by way of example only, with reference to the accompanying drawings, of which:

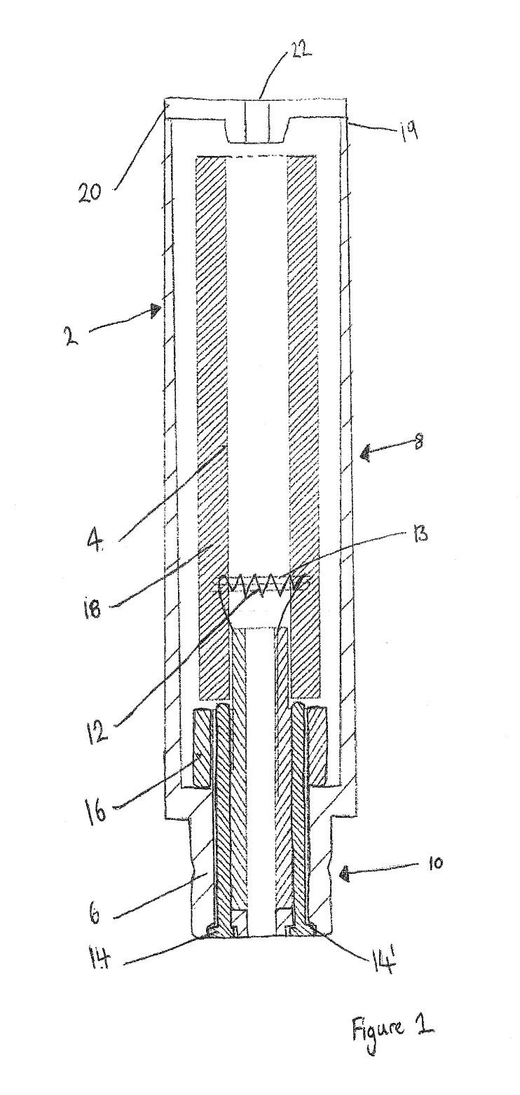

FIG. 1 is a side cross sectional view of an embodiment of the electronic cigarette atomizer of the present invention.

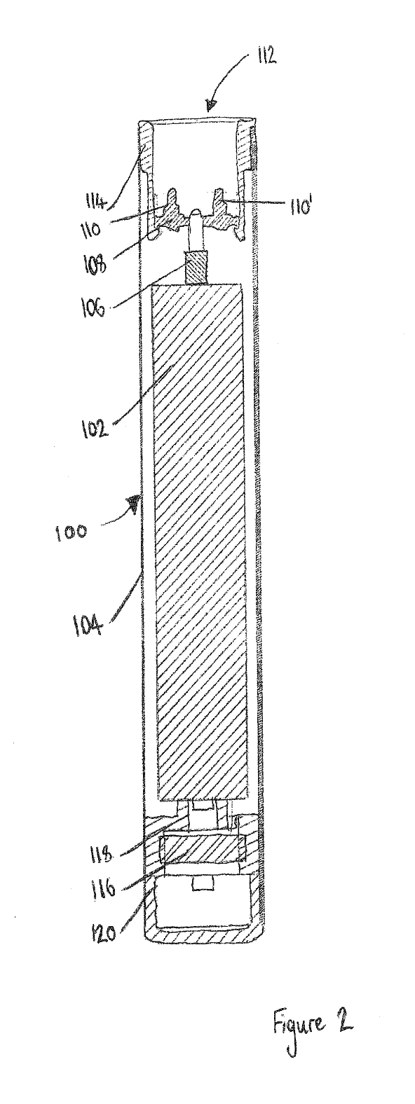

FIG. 2 is a side cross sectional view of an embodiment of a power supply component of the electronic cigarette of the present invention.

FIG. 1 illustrates an embodiment of the atomizer of the first and second aspects of the present invention for use in an electronic cigarette of the third and fourth aspects. The atomizer 2 includes an inner pipe in the form of high temperature pipe 4 located within and connected to an outer housing in the form of an atomizer pipe 6.

The atomizer pipe 6 is substantially cylindrical in shape and includes a main body portion 8 and an extended end portion 10. The diameter of the extended end portion 10 is marginally smaller in size than the diameter of the main body portion 8.

Located within the high temperature pipe 4 is a heating element in the form of heating wire 12 which is wrapped around a wick 13. Each end of the heating wire 12 is electrically connected to electrical connector pins 14, 14′. A fastening sleeve in the form of silicone sleeve 16 is provided within the atomizer 2 which ensures that the heating wire 12 and the electrical connector pins 14, 14′ remain in contact. The silicone sleeve 16 removes the need to solder the heating wire 12 to the connector pins 14, 14′ thus removing the associated disadvantages.

The opposing ends of the electrical connector pins 14, 14′ to the ends connected to the heating wire 12 protrude into the extended end portion 10 of the atomizer pipe 6 from within the main body portion 8.

In the embodiment illustrated in FIG. 1 there is also provided a liquid absorbent material in the form of tobacco cotton 18 wound around the outer surface of the high temperature pipe 4. Tobacco cotton 18 is connected to the wick 13 such that liquid is drawn from within the tobacco cotton 18 towards the heating wire 12.

The opposing end of the atomizer pipe 6 to the extended end portion 10 includes a mouthpiece 19. A cover 20 formed from silicone covers the mouthpiece 19 and has an aperture 22 located therein for the expulsion of vapour generated within the atomizer pipe 6.

In the illustrated embodiment, the atomizer pipe 6 is formed from polypropylene. It is envisaged, however, that the atomizer pipe 6 may be formed from any suitable material including other plastics materials or indeed any combination thereof.

FIG. 2 illustrates an embodiment of a power supply component 100 of the electronic cigarette of the present invention. The power supply component 100 includes a power supply means in the form of a battery 102 located within a battery conduit 104.

At a first end of the conduit 104 the battery 102 is connected via a battery socket 106 to a first printed circuit board 108. The first printed circuit board 108 is connected to electrical connection pins 110, 110′ and is operable to control the power supplied to the pins 110, 110′. The electrical connection pins 110, 110′ are located within a recess 112 within one end of the conduit 104 in which there is also located a plastic sleeve 114.

At the opposing end of the conduit 104, the battery 102 is connected to a second printed circuit board 116 via a silicone cap 118. The second printed circuit board 116 is operable to control the operation of an LED indicator 120 operable to indicate the operational status of the electronic cigarette.

Referring now to FIGS. 1 and 2, an embodiment of the electronic cigarette of the present invention will be described.

The electronic cigarette is formed by connecting the atomizer 2, as illustrated in FIG. 1, to the power supply component 100, as illustrated in FIG. 2. This is achieved by locating the extended end portion 10 of the atomizer 2 into the recess 112 within the end of the conduit 104 of the power supply component 100. The atomizer 2 and the power supply component 100 are retained in this position by the frictional engagement of the outer surface of the extended end portion 10 of the atomizer pipe 6 and the plastic sleeve 114. In this configuration, the electrical connection pins 110, 110′ of the power supply component 100 contact the electrical connector pins 14, 14′ on the atomizer 2 forming an electrical connection between the atomizer 2 and the power supply component 100. In this way, the heating wire 12 is powered by the battery 102.

The above embodiment is described by way of example only. Many variations are possible without departing from the scope of the invention as defined in the appended claims.

1. An electronic cigarette atomizer comprising:
an outer housing enclosing an inner pipe; and
a heating element located substantially within the inner pipe which is electrically connected to a least one electrical connector pin;
wherein the heating element and the or each electrical connector pin are secured in contact with each other with a fastening sleeve.

2. The atomizer of claim 1 wherein the fastening sleeve is formed from a resilient material.

3. The atomizer of claim 2 wherein the resilient material comprises silicone.

4-5. (canceled)

6. The atomizer of claim 1 wherein the outer housing comprises a main body portion enclosing the inner pipe and the heating wire, and an extended portion which protrudes from the main body portion.

7. The atomizer of claim 6 wherein the extended portion comprises a connection means operable to connect the atomizer to a further component of an electronic cigarette.

8. The atomizer of claim 7 wherein the or each electrical connector pin extends from within the main body portion of the atomizer into the extended portion such that the or each pin may be electrically connected to the further component of an electronic cigarette via at least one electrical connection located within the further component.

9. The atomizer of claim 8 wherein the fastening sleeve is configured such that that it ensures that the or each electrical connector pin is correctly aligned with respect to the at least one electrical connection on the further component of an electronic cigarette.

10. The atomizer of claim 9 wherein the fastening sleeve comprises a substantially elliptical cross-section which may be located within the outer housing of the atomizer in either a first orientation or a second orientation.

11. The atomizer of claim 10 wherein the or each electrical connector pin is correctly aligned with an electrical connection on the further component of an electronic cigarette independent of the orientation of the fastening sleeve.

12-13. (canceled)

14. The atomizer of claim 1 wherein the atomizer is configured such that it is releasably connectable with a further component of an electronic cigarette by means of a plug and socket connection

15. (canceled)

16. An electronic cigarette atomizer which is releasably connectable to a further component of an electronic cigarette by means of a plug and socket connection.

17. (canceled)

18. The atomizer of claim 16 comprising a main body portion and an extended portion which protrudes from a portion of the main body portion and comprises the releasable connection means operable to connect the atomizer to a further component of an electronic cigarette.

19. The atomizer of claim 18 comprising electrical connector pins extending from within the main body portion of the atomizer into the extended portion such that they may be electrically connected to the further component of an electronic cigarette.

20. The atomizer of claim 16 wherein a portion of the atomizer may be dimensioned such that it can be located within a recess or aperture within a further component of an electronic cigarette to form the plug and socket connection.

21. The atomizer of claim 16 wherein the atomizer may comprise a recess into which a portion of a further component of an electronic cigarette may be located to form the plug and socket connection.

22. The atomizer according to claim 16 wherein the further component of the electronic cigarette comprises a power supply.

23. The atomizer of claim 16 wherein the atomizer comprises a mouth piece having a cover located on an outer surface thereof

24. An electronic cigarette comprising:
an outer housing comprising a mouth piece operable in use to allow vapour produced within an atomizer located within or connected to the housing to be expelled therethrough;
wherein the mouth piece comprises a resilient material.

25. An electronic cigarette as claimed in claim 24 comprising:
an atomizer comprising:
an outer housing enclosing an inner pipe; and
a heating element located substantially within the inner pipe which is electrically connected to a least one electrical connector pin;
wherein the heating element and the or each electrical connector pin are secured in contact with each other with a fastening sleeve; and
a power supply component comprising a power supply means and at least one electrical connector probe electrically connected to the power supply means.

26. The electronic cigarette of claim 25 wherein the atomizer and power supply component are releasably connectable by means of a plug and socket connection.

27-30. (canceled)
